(19) United States
(12) Patent Application Publication
(10) Pub. No.: US 2008/0049673 A1
(43) Pub. Date: Feb. 28, 2008

(54) Method of Switching Multi-Mode Multi-Ban Mobile Communication Terminal in Multi Access Communication Nerwork

(76) Inventors: Seong-Soo Park, Seoul (KR); Sang-Shin Lee, Seoul (KR); Dong-Hahk Lee, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 10/587,245

(22) PCT Filed: Jan. 26, 2005
(86) PCT No.: PCT/KR05/00212

§ 371 Date: Apr. 16, 2007

(30) Foreign Application Priority Data
Jan. 26, 2004 (KR) 10-2004-0004789

(51) Int. Cl. H04Q 7/00

(52) U.S. Cl. 370/331

(57) ABSTRACT

The present invention relates to a mode switching method for a multi-mode multiband mobile communication terminal in a multi-access communication network, which is capable of effectively providing handoff to the user mobile communication terminal in heterogeneous communication networks. The method includes the first step of calculating the link quality of a Wireless Local Area Network (WLAN); the second step of comparing the link quality with a first reference value; the third step of measuring a signal from the portable Internet having coverage wider than that of the current communication network if it is determined that the link quality of the WLAN is lower than the first reference value; the fourth step of calculating the link quality of the portable Internet; and the fifth step of switching the mode of the mobile communication terminal to perform handoff to the portable Internet if it is determined that the link quality of the portable Internet is higher than a second reference value.

### TECHNICAL FIELD

The present invention relates to a mode switching method for a multi-mode multi-band mobile communication terminal in a multi-access communication network, which is capable of effectively providing handoff in a plurality of heterogeneous communication networks including a mobile communication network.

### BACKGROUND ART

Mobile communication service started with the low-quality, voice call-oriented first generation mobile communication service, which was provided by the Advanced Mobile Phone Service (AMPS) that started from the late 1980's, and is continuously developing. In the second generation mobile communication service, it is possible to provide improved voice call service and low-speed (14.4 Kbps) data service that are provided by digital cellular type Global System for Mobile Communications (GSM), Code Division Multiple Access (CDMA) and Time Division Multiple Access (TDMA). Furthermore, in the 2.5 generation mobile communication service, frequencies in the GHz band are guaranteed and globally usable Personal Communication Service (PCS) has been developed, so that it is possible to provide improved voice call service and low-speed (144 Kbps) data service.

Mobile communication networks for mobile communication service up to the 2.5 generation are each equipped with a variety of communication equipment, including user terminals, a Base Transceiver System (BTS), a Base Station Controller (BSC), a Mobile Switching Center (MSC), a Home Location Register (HLR) and a visitor Location Register (VLR).

The third generation mobile communication service is classified into asynchronous mode Wideband CDMA (WCDMA) service that was proposed chiefly by the 3 Generation Partnership Project (3GPP), or synchronous mode CDMA-2000 service that is proposed chiefly by the 3GPP2. In particular, the WCDMA system is based on a wireless protocol recommended by the IMT-2000 service, and the WCDMA service is being provided or the provision of the WCDMA service is prepared by many communication service providers worldwide.

Furthermore, with the development of mobile communication technology, a high-speed public Wireless Local Area Network (WLAN), which is provided in areas called “hot spots,” and a portable Internet system are being developed, and the functions of user terminals are becoming diversified.

Accordingly, the handoff between the above-described systems arises as an important issue, and solutions to the related problems thereof are demanded.

### DISCLOSURE OF THE INVENTION

To solve the above-described problems, an object of the present invention is to provide a mode switching method for a multi-mode multi-band mobile communication terminal in a multi-access communication network, which is capable of providing effective handoff to the user mobile communication terminal in heterogeneous communication networks, including a WLAN and the portable Internet as well as various types of mobile communication networks.

### BRIEF DESCRIPTION OF THE DRAWINGS

FIG. 1 is a diagram illustrating an example of the regions of a multi-access communication network according to the present invention;

FIG. 2 is a block diagram illustrating the construction of a multi-band multi-mode mobile communication terminal according to the present invention;

FIG. 3 is a flowchart illustrating a handoff process in the region of a WLAN according to the present invention;

FIG. 4 is a flowchart illustrating a handoff process in the region of the portable Internet according to the present invention; and

FIG. 5 is a flowchart illustrating a handoff process in the region of a mobile communication network according to the present invention.

### BEST MODE FOR CARRYING OUT THE INVENTION

To achieve the above-described object, the present invention provides a mode switching method for a multi-mode multi-band mobile communication terminal in a multi-access communication network, the multi-mode multi-band mobile communication terminal having modems for communication with a plurality of communication networks having different coverages, including the first step of calculating the link quality of a WLAN in which the mobile communication terminal is currently located; the second step of comparing the link quality calculated at the first step with a first reference value preset in connection with the WLAN; the third step of measuring a signal from a portable Internet having coverage wider than that of the current communication network if, as a result of the comparison at the second step, it is determined that the link quality of the WLAN is lower than the first reference value; the fourth step of calculating the link quality of the portable Internet; and the fifth step of switching the mode of the mobile communication terminal to perform handoff to the portable Internet if it is determined that the link quality of the portable Internet calculated at the fourth step is higher than a second reference value.

In addition, the present invention provides a mode switching method for a multi-mode multi-band mobile communication terminal in a multi-access communication network, the multi-mode multi-band mobile communication terminal having modems for communication with a plurality of communication networks having different coverages, including the first step of measuring a signal from a WLAN having coverage narrower than that of a portable Internet in which the mobile communication terminal is currently located; the second step of calculating the link quality of the WLAN signal measured at the first step; the third step of comparing the link quality of the WLAN signal measured at the second step with a preset first reference value; and the fourth step of switching the mode of the mobile communication terminal to perform handoff to the WLAN if, as a result of the comparison at the third step, the link quality of the WLAN is higher than the first reference value.

In addition, the present invention provides a mode switching method for a multi-mode multi-band mobile communication terminal in a multi-access communication network, the multi-mode multi-band mobile communication terminal having modems for communication with a plurality of communication networks having different coverages, including the first step of measuring a signal from a WLAN having coverage narrower than that of a mobile communication network in which the mobile communication terminal is currently located; the second step of calculating the link quality of the WLAN signal measured at the first step; the third step of comparing the link quality of the WLAN signal measured at the second step with a preset first reference value; the fourth step of measuring a signal from a portable Internet if, as a result of the comparison at the third step, the link quality of the WLAN is not higher than a first reference value; the fifth step of measuring the link quality of the portable Internet signal measured at the fourth step; and the sixth step of switching the mode of the mobile communication terminal to perform handoff to the portable Internet if the link quality of the portable Internet calculated at the fifth step is higher than a second reference value.

The present invention is described in detail with reference to the accompanying drawings below.

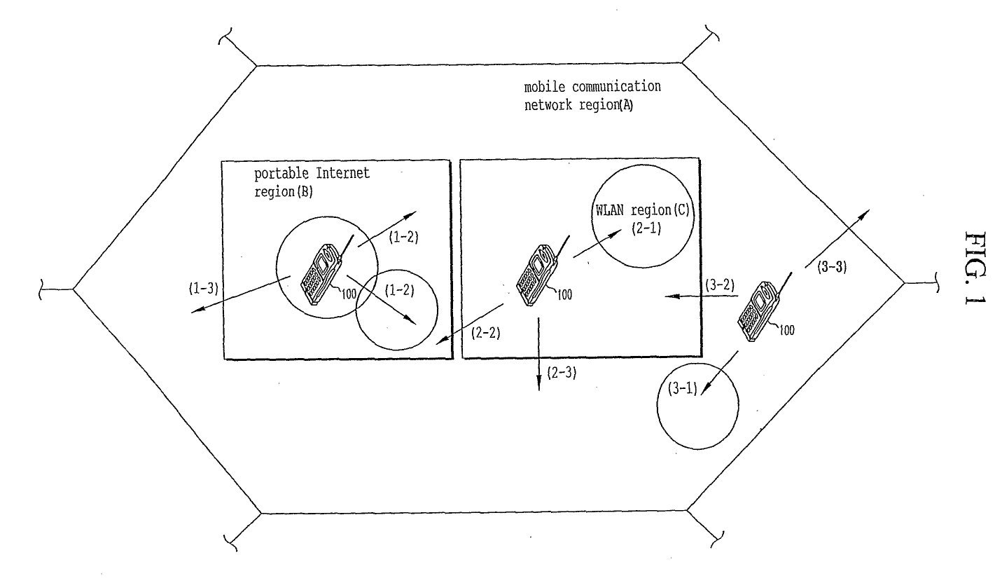

FIG. 1 is a diagram illustrating an example of the regions of a multi-access communication network according to the present invention. With reference to FIG. 1, the structure of the multi-access-enabled communication network, to which the method according to the present invention is applied, is described below.

The multi-access communication network according to the embodiment of the present invention may be divided into a first wireless network (mobile communication network), a second wireless network (portable Internet) and a third wireless network (WLAN that is a public wireless network) for convenience's sake.

The above-described first to third wireless communication networks have different data transmission rates. In general, the mobile communication network, that is, the first wireless network, has an effective transmission rate of about 100 Kbps, the portable Internet, that is, the second wireless network, has an effective transmission rate of about 300 Kbps, and the WLAN, that is, the third wireless network, has an effective transmission rate of about 500 Kbps. That is, the order of the transmission rates may be expressed as WLAN>portable Internet>mobile communication network.

As a result, the WLAN is chiefly deployed in areas that are identified as hot spots and have heavy use of communication, and generally have the narrowest coverage.

The above-described first to third wireless networks have coverages according to the order of mobile communication network (A)>portable Internet (B)>WLAN (C). In this case, the mobile communication network includes a CDMA-2000 network, that is, a synchronous communication network, and a WCDMA network, that is, an asynchronous communication network, though not indicated particularly, and the handoff between the synchronous mobile communication network and the asynchronous mobile communication network follows a conventional scheme simply using signal intensity or the method of the present invention that will be described below.

In the above-described multi-access communication network, the mobile communication terminal can perform handoff in the cases in which it is located in the region of the WLAN, the region of the portable Internet and the region of the mobile communication network, which may be classified as described below.
1-1) WLAN→WLAN
1-2) WLAN→portable Internet
1-3) WLAN→mobile communication network
2-1) portable Internet→WLAN
2-2) portable Internet→portable Internet
2-3) portable Internet→mobile communication network
3-1) mobile communication network→WLAN
3-2) mobile communication network→portable Internet
3-3) mobile communication network→mobile communication network

In each of the above-described cases, when the mobile communication terminal is located in the region of a specific communication network, handoff is performed in such a way that the link quality of the current communication network is compared with that of an adjacent communication network and a handoff to the communication network having superior link quality (communication network having a higher transmission rate) is performed.

When a transmission rate based on the link quality of the current communication network is lower than a preset reference value in the case where there is not a communication network having link quality superior to that of the current communication network, handoff to an upper communication network, that is, a communication network having a coverage wider than that of the current communication network, is performed.

However, even though a transmission rate based on the link quality of the current communication network is lower than a preset reference value, a current communication state is maintained if the transmission rate is higher than an effective transmission rate that is measured based on a signal received from the adjacent communication network.

For example, if the adjacent wireless network is the portable Internet and the link quality thereof is about 300 Kbps when the mobile communication terminal is located in the region of a WLAN having a transmission rate of 500 Kbps and the transmission rate based on then link quality of the current WLAN is 200 Kbps, which is lower than the preset reference value (for example, about 300 Kbps), the mobile communication terminal performs handoff from the region of the WLAN to the region of the portable Internet.

However, if the adjacent wireless network is the mobile communication network when the transmission rate based on the link quality of the current WLAN is 200 Kbps, which is lower than the preset reference value (for example, 300 Kbps), the link quality of the mobile communication network is about 100 Kbps, so that the mobile communication terminal maintains current WLAN communication.

In order to control the handoff of the mobile communication terminal according to the above-described method, the handoff is performed by measuring the link quality of communication networks, determining an available data transmission rate based on the link quality, and comparing the available data transmission rate with the preset reference value.

The reference value is set differently according to the case in order to perform efficient handoff. In the present embodiment, an effective transmission rate is calculated using a Packet Error Rate (PER) as a parameter for determining the link quality of the communication networks.

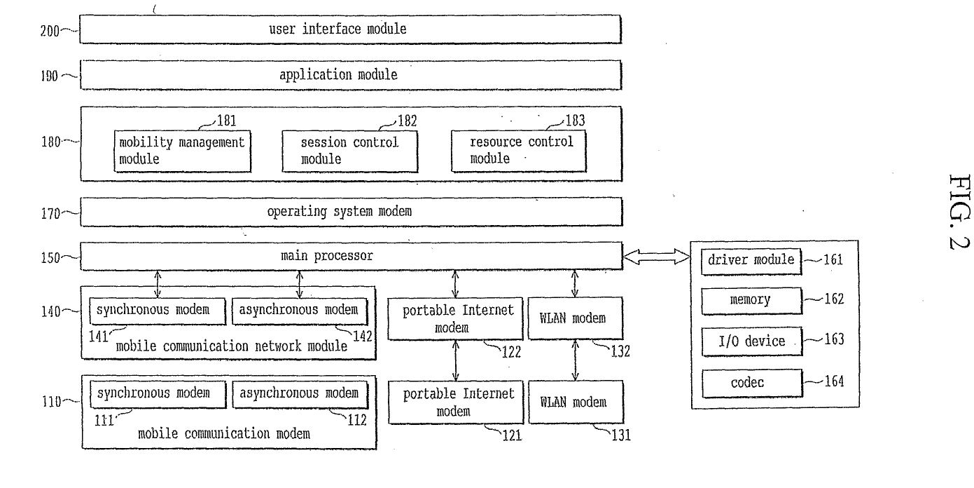

FIG. 2 is a block diagram illustrating the construction of a multi-band multi-mode mobile communication terminal according to the present invention.

The mobile communication terminal according to the present invention, which is shown in FIG. 2, is a multi-band multi-mode mobile communication terminal capable of accessing all of the above-described first to third communication networks.

The platform of the mobile communication terminal 100 according to the present invention includes a mobile communication modem 110 for performing communication with the mobile communication network, a mobile communication network module 140 for controlling mobile communication network communication, a portable Internet modem 121 for performing communication with the portable Internet, a portable Internet module 122 for controlling the portable Internet communication, a WLAN modem 131 for performing communication with the WLAN that is a public wireless network, and a WLAN module 132 for controlling WLAN communication.

The mobile communication terminal 100 according to the present invention includes a main processor 150 for performing overall operation and access control for handoff to a communication network, and an operating system module 170. The main processor 150 operates in connection with the operating system module 170. The operating system module 170 is the operating system of the mobile communication terminal, and may be one of the available operating systems, such as Real Time Execution (REX) and the Pioneer Server Operating System (PSOS).

A driver module 161, memory 162 for storing data, an Input/Output (I/O) device 163 for connecting with peripheral devices, and a codec 164 for processing voice are connected to the main processor 150 of the platform of the mobile communication terminal 100.

The peripheral devices, such as a key input unit (not shown) for receiving key commands from a user, a sound output unit (not shown) and a display unit (not shown), are connected to the I/O device 163. The key input unit receives key inputs from the user and transmits the key inputs to the main processor 150, the sound output unit outputs sound through the speaker of the mobile communication terminal under the control of the main processor 150, and the display unit displays all visual representations, including information about the operation of the mobile communication terminal.

Furthermore, the platform of the mobile communication terminal 100 includes a control module 180 having a control function, including mobility control, an application module 190 for executing applications, and a user interface module 200.

The control module 180 includes a mobility management module 181 for managing mobility through mobile IP, a session control module 182 for managing call connections and sessions, and a resource control module 183 for managing system resources.

Each of the mobile communication network module 140, the portable Internet module 122 and the WLAN module 132 calculates an effective transmission rate by detecting the signal of a corresponding communication network through a corresponding modem and using the PER (Packet Error Rate) as a parameter for determining the link quality of the communication network signal, and transmits the transmission rate to the main processor 150.

Accordingly, the main processor 150 receives data transmitted from the mobile communication module 140, the portable Internet module 122 and the WLAN module 132, determines whether to perform handoff according to the above-described method, and performs the handoff to a communication network satisfying a preset handoff condition through a corresponding module and modem when the handoff condition is satisfied.

For this purpose, in each of the above-described cases, when the mobile communication terminal 100 is located in the region of a specific communication network, the main processor 150 compares the link quality of the current communication network with that of an adjacent communication network and performs handoff to the communication network having superior link quality (communication network having a high transmission rate), in accordance with the criteria of the present invention.

Furthermore, if a transmission rate based on the link quality of the current communication network is lower than the preset reference value when there is no communication network having link quality superior to that of the current communication network, handoff to an upper communication network, that is, a communication network having coverage wider than that of the current communication network, is performed.

However, if a transmission rate based on the link quality of the current communication network is higher than an effective transmission rate based on a signal received from an adjacent communication network even through the transmission rate based on the link quality is lower than the preset reference value, a current communication state is maintained.

The above-described method according to the present invention is described through handoff processes in individual communication networks in detail below.

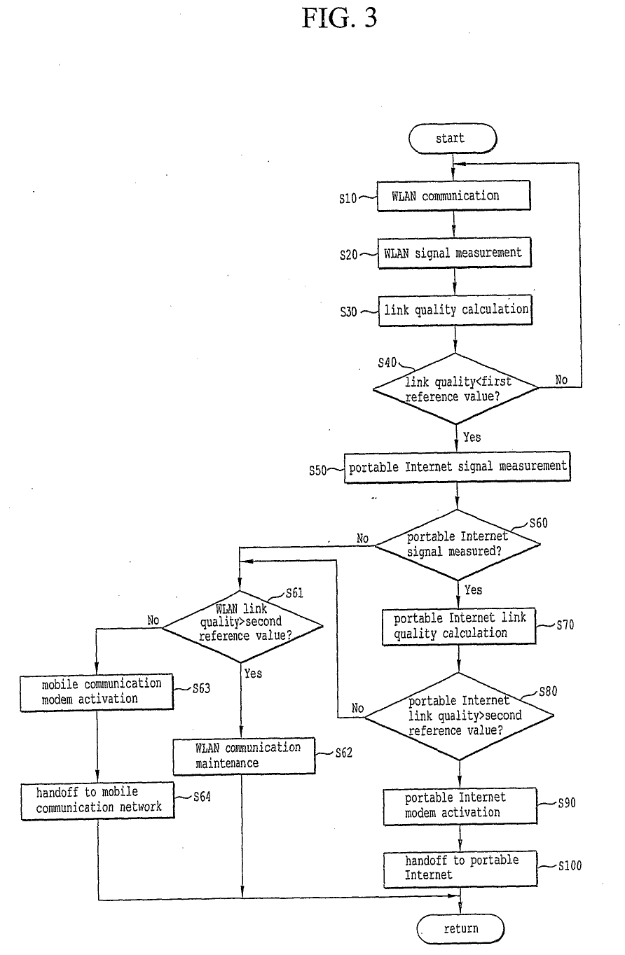

FIG. 3 is a flowchart illustrating a handoff process in the region of the WLAN according to the present invention, which corresponds to the above-described cases 1-1), 1-2) and 1-3).

Referring to FIG. 3, the mobile communication terminal 100 is located in the region of the WLAN at step S10 and measures the signal from the WLAN at step S20. The mobile communication terminal 100 calculates an effective transmission rate using a parameter for determining the link quality of the measured signal from the WLAN, for example, a PER at step S30.

The mobile communication terminal 100 determines whether the calculated link quality is lower than a first reference value (for example, 500 Kbps) at step S40.

In this case, if it is determined that the PER is not lower than the first reference value at step S40, the PER is equal to or higher than the first reference value, so that the mobile communication terminal 100 maintains current WLAN communication.

In contrast, if it is determined that the link quality is lower than the first reference value at step S40, the mobile communication terminal 100 measures a signal from the portable Internet at step S50. Thereafter, at step S60, it is determined whether the signal from the portable Internet has been measured at step S50.

If, at step S60, it is determined that the signal from the portable Internet has not been measured, it is determined whether the link quality of the current WLAN signal is higher than a second reference value (for example, about 100 Kbps) that is set below the first reference value at step S61.

If, at step S61, the link quality of the current WLAN signal is higher than the second reference value, the current portable Internet signal is not measured, and it is determined that link quality of the WLAN is superior to that using of mobile communication network, so that the mobile communication terminal 100 maintains communication using the current WLAN at step S62.

In contrast, if, at step S61, it is determined that the link quality of the current WLAN signal is not higher than the second reference value, the mobile communication modem 110 is activated at step S63, and handoff to the mobile communication network is performed at step S64. In this case, the mobile communication terminal 100 may perform handoff to a synchronous communication network or an asynchronous communication network, in which case the mode of the mobile communication terminal is switched and handoff is performed with priority being given to the asynchronous communication depending on signal intensity.

In the meantime, if, at step S60, it is determined that the signal from the portable Internet has been measured, the mobile communication terminal 100 calculates the link quality of the portable Internet signal at step S70. Furthermore, it is determined whether the calculated link quality of the portable Internet signal is higher than the preset second reference value at step S80.

If the link quality of the portable Internet signal is higher than the second reference value at step S80, the mobile communication terminal 100 activates the portable Internet modem 121 at step S90, and the mode is switched to the portable Internet and handoff is performed at step S100.

In contrast, if the link quality of the portable Internet signal is not higher than the second reference value at step S80, the mobile communication terminal 100 determines whether the link quality of the WLAN is higher than the second reference value at step S61. If, at step S61, the link quality of the WLAN is higher than the second reference value, current WLAN communication is maintained at step S62.

In contrast, if, at step S61, it is determined that the link quality of the WLAN is not higher than the second reference value, the mobile communication terminal 100 activates the mobile communication modem 110 at step S63, and the mode is switched to the mobile communication network and handoff is performed at step S64. In this case, the mobile communication terminal 100 may perform handoff to a synchronous communication network or an asynchronous communication network, in which case the mode is switched for handoff and the handoff is performed with priority being given to the asynchronous communication depending on signal intensity.

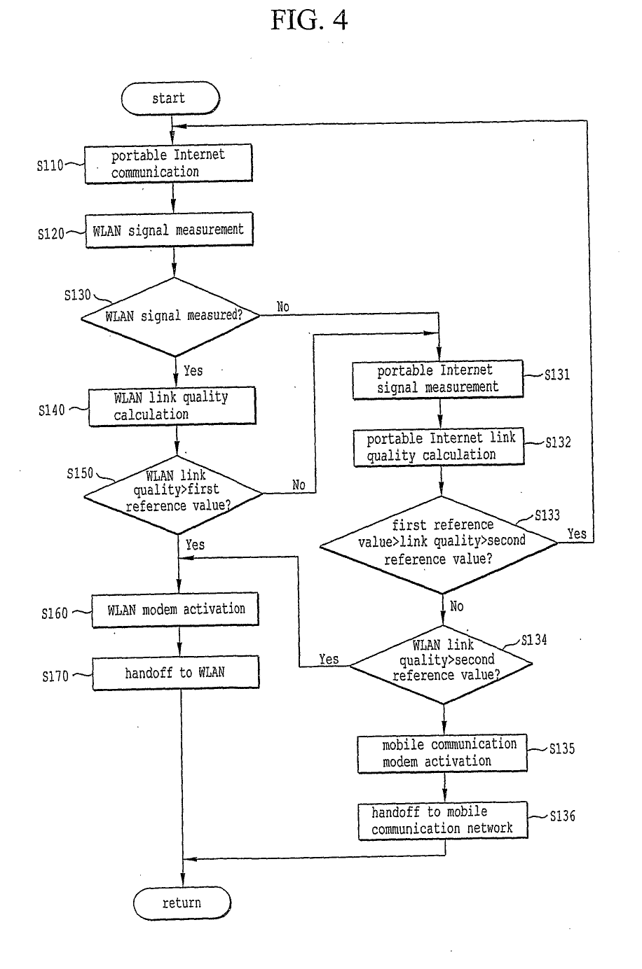

FIG. 4 is a flowchart illustrating a handoff process in the region of the portable Internet according to the present invention, which corresponds to the above-described cases 2-1), 2-2) and 2-3).

Referring to FIG. 4, the mobile communication terminal 100 is located in the region of the portable Internet at step S110 and measures the signal from the WLAN at step S120. Furthermore, it is determined whether the signal from the WLAN has been measured at step S130.

If, at step S130, it is determined that the signal from the WLAN has been measured, an effective transmission rate is calculated using a parameter for determining the link quality of the measured WLAN signal, for example, a PER, at step S140.

The mobile communication terminal 100 determines whether the calculated link quality is higher than a preset first reference value (for example, 500 Kbps) at step S150. In this case, if the link quality is higher than the first reference value at step S150, the mobile communication terminal 100 activates the WLAN modem at step S160, and the mode is switched to WLAN communication and handoff is performed at step S170.

Meanwhile, if it is determined that the link quality is not higher than the first reference value at step S150 or it is determined that the signal from the WLAN has not been measured at step S130, the mobile communication terminal 100 measures a signal from the portable Internet at step S131. Thereafter, the link quality of the signal from the portable Internet is calculated at step S132. Thereafter, it is determined whether the calculated link quality of the portable Internet is lower than the first reference value and higher than a second reference value that is set below the first reference value at step S133.

If, at step S133, it is determined that the link quality of the portable Internet signal is lower than the first reference value and higher than the second reference value, the mobile communication terminal 100 maintains the current portable Internet communication.

Meanwhile, if it is determined that the link quality of the portable Internet signal deviates from the range from the first reference value to the second reference value at step S133, it is determined whether the link quality of the WLAN is higher than the second reference value at step S134.

If it is determined that the link quality of the WLAN is higher than the second reference value at step S134, the WLAN modem 131 is activated at step S160 and handoff to the WLAN is performed at step S170.

In contrast, if the link quality of the WLAN is not higher than the second reference value at step S134, it is determined that the link quality using the mobile communication network is superior, the mobile communication modem 110 is activated at step S135, and the mode is switched to the mobile communication network and handoff is then performed at step S136. In this case, the mobile communication terminal 100 may perform handoff to a synchronous communication network or an asynchronous communication network, in which case the mode is switched for handoff and the handoff is performed with priority being given to the asynchronous communication depending on signal intensity.

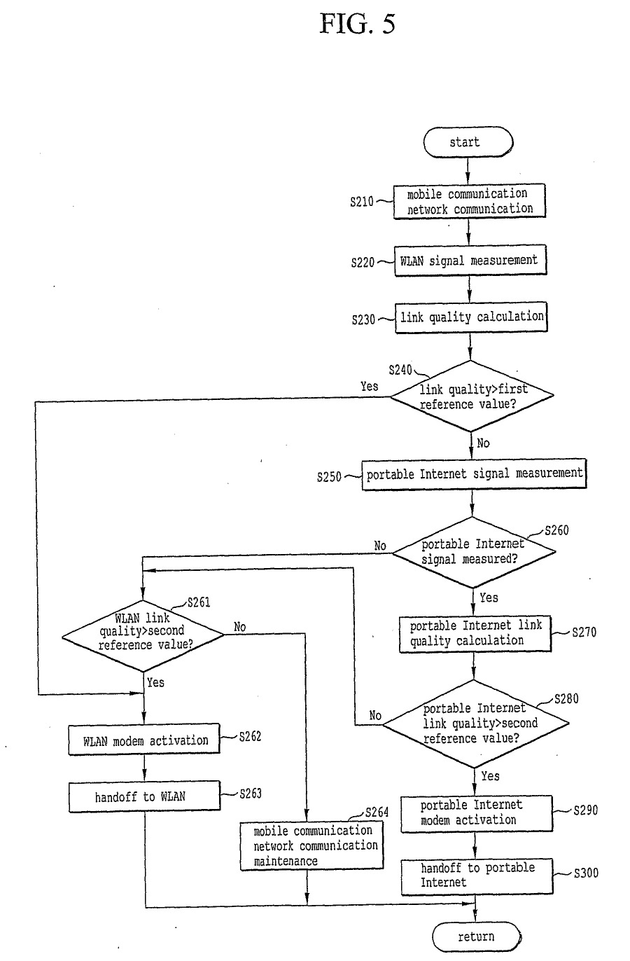

FIG. 5 is a flowchart illustrating a handoff process in the region of the mobile communication network according to the present invention, which corresponds to the above-described cases 3-1), 3-2) and 3-3).

Referring to FIG. 5, the mobile communication terminal 100 is located in the region of the mobile communication network at step S210 and measures the signal from the WLAN at step S220. An effective transmission rate is calculated using a parameter for determining the link quality of the WLAN signal measured at step S220, for example, a PER, at step S230.

The mobile communication terminal 100 determines whether the link quality calculated at step S230 is higher than the preset first reference value (for example, 500 Kbps) at step S240. In this case, if the link quality is higher than the first reference value at step S240, the mobile communication terminal 100 activates the WLAN modem at step S262, and the mode is switched to WLAN communication and handoff is performed at step S263.

Meanwhile, if it is determined that the link quality is not higher than the first reference value at step S240, the mobile communication terminal 100 measures a signal from the portable Internet at step S250. Thereafter, it is determined whether a signal from the portable Internet has been measured at step S260.

If it is detected that the signal from the portable Internet has been measured at step S260, the mobile communication terminal 100 calculates the link quality of the portable Internet at step S270. Thereafter, it is determined whether the calculated link quality is higher than a preset second reference value that is set below the first reference value at step S280.

If it is determined that the link quality of the portable Internet is higher than the second reference value at step S280, the mobile communication terminal 100 activates the portable Internet modem 121 at step S290, and the mode is switched to the portable Internet and handoff is performed at step S300.

In contrast, if it is determined that the link quality of the portable Internet is not higher than the second reference value at step S280 or it is determined that the signal from the portable Internet has not been measured at step S260, it is determined whether the link quality of the WLAN is higher than the second reference value at step S261.

If it is determined that the link quality of the WLAN is not higher than the second reference value at step S261, the mobile communication terminal 100 maintains current mobile communication network communication at step S264.

In contrast, if it is determined that the link quality of the WLAN is higher than the second reference value at step S261, the WLAN modem 131 is activated at step S262, and the mode is switched to the WLAN and handoff is performed at step S263.

In accordance with the present invention described above, those skilled in the technical field to which the present invention pertains can understand that the present invention can be implemented in other practical forms without changes in technical spirit or essential feature. Accordingly, it should be appreciated that the above-described embodiments are illustrative and are not restrictive in every respect. Furthermore, it should be appreciated that the scope of the present invention is represented by the following claims rather than the above-described detailed description, and all the modifications and variants derived from the meaning and scopes of the claims and the equivalents thereof pertain to the scope of the present invention.

### INDUSTRIAL APPLICABILITY

As described above, in the mode switching method for a multi-mode multi-band mobile communication terminal in a multi-access communication network in accordance with the present invention, there is an advantage in that the method is capable of effectively providing handoff to the user mobile communication terminal in heterogeneous communication networks, including a WLAN and the portable Internet as well as various types of mobile communication networks.

1. A mode switching method for a multi-mode multi-band mobile communication terminal in a multi-access communication network, the multi-mode multi-band mobile communication terminal having modems for communication with a plurality of communication networks having different coverages, comprising:
the first step of calculating link quality of a Wireless Local Area Network (WLAN) in which the mobile communication terminal is currently located;
the second step of comparing the link quality calculated at the first step with a first reference value preset in connection with the WLAN;
the third step of measuring a signal from a portable Internet having coverage wider than that of the current communication network if, as a result of the comparison at the second step, it is determined that the link quality of the WLAN is lower than the first reference value;
the fourth step of calculating link quality of the portable Internet; and
the fifth step of switching a mode of the mobile communication terminal to perform handoff to the portable Internet if it is determined that the link quality of the portable Internet calculated at the fourth step is higher than a second reference value.

2. The mode switching method according to claim 1, further comprising the steps of:
determining whether the link quality of the WLAN is higher than the second reference value if the signal from the portable Internet has not been measured at the third step; and
maintaining communication with the WLAN if, as a result of the determination, the link quality of the WLAN is higher than the second reference value.

3. The mode switching method according to claim 2, further comprising the step of switching the mode of the mobile communication terminal to perform handoff to the mobile communication terminal if the link quality of the WLAN is not higher than the second reference value.

4. The mode switching method according to claim 1, further comprising the steps of:
determining whether the link quality of the WLAN is higher than the second reference value if the link quality of the portable Internet calculated at the fourth step is not higher than the second reference value;
maintaining communication with the WLAN if, as a result of the determination, the link quality of the WLAN is higher than the second reference value; and
switching the mode of the mobile communication terminal to perform handoff to the mobile communication network if the link quality of the WLAN is not higher than the second reference value.

5. The mode switching method according to claim 1, wherein the link quality is a data transmission rate of a corresponding communication network based on a Packet Error Rate (PER).

6. The mode switching method according to claim 1, wherein the reference value is a minimal effective transmission rate of a current communication network.

7. A mode switching method for a multi-mode multi-band mobile communication terminal in a multi-access communication network, the multi-mode multi-band mobile communication terminal having modems for communication with a plurality of communication networks having different coverages, comprising:
the first step of measuring a signal from a WLAN having coverage narrower than that of a portable Internet in which the mobile communication terminal is currently located;
the second step of calculating link quality of the WLAN signal measured at the first step;
the third step of comparing the link quality of the WLAN signal measured at the second step with a preset first reference value; and
the fourth step of switching a mode of the mobile communication terminal to perform handoff to the WLAN if, as a result of the comparison at the third step, the link quality of the WLAN is higher than the first reference value.

8. The mode switching method according to claim 7, further comprising the steps of:
measuring a signal from a portable Internet if the signal from the WLAN has not been measured at the first step;
calculating link quality of the measured signal;
determining whether the link quality of the WLAN is higher than a second reference value preset for a corresponding communication network if the link quality of the signal is not higher than the second reference value and not lower than the first reference value; and
switching the mode of the mobile communication terminal to perform handoff to a mobile communication network if the link quality of the WLAN is not higher than the second reference value.

9. The mode switching method according to claim 8, further comprising the step of switching the mode of the mobile communication terminal to perform handoff to the WLAN if the link quality of the WLAN is higher than the second reference value.

10. The mode switching method according to claim 7, further comprising the steps of:
measuring a signal from a portable Internet if, as a result of the comparison at the third step, the link quality of the WLAN is not higher than the first reference value;
calculating link quality of the measured signal;
determining whether the link quality of the WLAN is higher than a second reference value preset for a corresponding communication network if the link quality of the signal is not higher than the second reference value and not lower than the first reference value; and
switching the mode of the mobile communication terminal to perform handoff to a mobile communication terminal if the link quality of the WLAN is lower than the second reference value.

11. The mode switching method according to claim 10, further comprising the step of switching the mode of the mobile communication terminal to perform handoff to the WLAN if the link quality of the WLAN is higher than the second reference value.

12. The mode switching method according to claim 7, wherein the link quality is a data transmission rate of a corresponding communication network based on a PER.

13. The mode switching method according to claim 7, wherein the reference value is a minimal effective transmission rate of a corresponding communication network.

14. A mode switching method for a multi-mode multi-band mobile communication terminal in a multi-access communication network, the multi-mode multi-band mobile communication terminal having modems for communication with a plurality of communication networks having different coverages, comprising:
the first step of measuring a signal from a WLAN having coverage narrower than that of a mobile communication network in which the mobile communication terminal is currently located;
the second step of calculating link quality of the WLAN signal measured at the first step;
the third step of comparing the link quality of the WLAN signal measured at the second step with a preset first reference value;
the fourth step of measuring a signal from a portable Internet if, as a result of the comparison at the third step, the link quality of the WLAN is not higher than a first reference value;
the fifth step of measuring link quality of the portable Internet signal measured at the fourth step; and
the sixth step of switching a mode of the mobile communication terminal to perform handoff to the portable Internet if the link quality of the portable Internet calculated at the fifth step is higher than a second reference value.

15. The mode switching method according to claim 14, further comprising the step of switching the mode of the mobile communication terminal to perform handoff to the WLAN if, as a result of the comparison at the third step, the link quality of the WLAN is higher than the first reference value.

16. The mode switching method according to claim 14, further comprising the steps of:
determining whether the link quality of the WLAN is higher than the second reference value if the signal from the portable Internet has not been measured at the fourth step;
switching a mode of the mobile communication terminal to perform handoff to the WLAN if the link quality of the WLAN is higher than the second reference value; and
maintaining communication with the mobile communication network if the link quality of the WLAN is not higher than the second reference value.

17. The mode switching method according to claim 14, further comprising the steps of:
determining whether the link quality of the WLAN is higher than the second reference value if the link quality of the portable Internet calculated at the fifth step is not higher than the second reference value;
switching a mode of the mobile communication terminal to perform handoff to the WLAN if the link quality of the WLAN is higher than the second reference value; and
maintaining communication with the mobile communication network if the link quality of the WLAN is not higher than the second reference value.

18. The mode switching method according to claim 14, wherein the link quality is a data transmission rate of a corresponding communication network based on a PER.

19. The mode switching method according to claim 14, wherein the reference value is a minimal effective transmission rate of a current communication network.
